(19) United States
(12) Patent Application Publication
(10) Pub. No.: US 2005/0043425 A1
(43) Pub. Date: Feb. 24, 2005

(54) Polyurethane foam

(76) Inventors: Christian Beck, Burscheid-Hilgen (DE); Joachim Wagner, Koln (DE); Hubert Ehbing, Odenthal (DE)

Correspondence Address: BAYER MATERIAL SCIENCE LLC, 100 BAYER ROAD, PITTSBURGH, PA, 15205, US

(21) Appl. No.: 10/920,004

(22) Filed: Aug. 17, 2004

(30) Foreign Application Priority Data
Aug. 20, 2003 (DE) 10338164.3

(51) Int. Cl. C08G 18/00

(52) U.S. Cl. 521/155

(57) ABSTRACT

The present invention relates to a process for the production of a polyurethane foam, comprising the reaction of a polyisocyanate and a polyol in the presence of a blowing agent and of particles. These particles are obtained by reacting carrier particles with a functionalising reagent G, wherein G contains reactive groups G¹ by means of which G can be chemically bonded to the surface of the carrier particles, and wherein G additionally contains reactive groups G² which, under the conditions of the polyurethane foam production, are reactive towards the NCO groups of the polyisocyanate, or towards the OH groups of the polyol, or both, and wherein G¹ and G² may be the same or different. The present invention relates also to a polyurethane foam obtained by this process and to products containing such a polyurethane foam. The present invention relates also to a composition containing a polyol and these particles. The present invention relates also to a composition containing a polyisocyanate and these particles. Both the mentioned compositions can be used to produce a polyurethane foam according to the invention.

### BACKGROUND OF THE INVENTION

The present invention relates to a process for the production of a polyurethane foam, comprising the reaction of a polyisocyanate and a polyol in the presence of a blowing agent and of particles which are obtained by reacting carrier particles with a functionalising reagent G. The functionalising reagent G contains reactive groups G¹ by means of which G can be chemically bonded to the surface of the carrier particles, and the functionalising reagent G additionally contains reactive groups G² which, under the conditions of the polyurethane foam production, are reactive towards the NCO groups of the polyisocyanate or towards the OH groups of the polyol (this means that the groups are reactive towards the NCO groups or towards the OH groups or towards both), and wherein G¹ and G² may be the same or different. This invention relates also to a polyurethane foam produced by this process and to products which contain such a polyurethane foam. The present invention relates also to a composition containing a polyol and the above-described particles. The present invention also relates to a composition containing a polyisocyanate and the above-described particles. Both the mentioned compositions can be used to produce a polyurethane foam according to the invention.

The process of the present invention allows the open cell content and the fineness of the cells of the polyurethane foam (PUR foamed material) produced by this process to be regulated. The particles according to the invention mentioned in the preceding paragraph are useful for the regulation of the open cell content and the fineness of the cells.

The open cell content or closed cell content of PUR foamed materials can be determined, for example, in accordance with standard ASTM D 2856. According to this standard, the accessible cell volume of a foam is determined by means of a porosity determination using an air pycnometer.

The flow resistance of a PUR foam is dependent on the open cell content and accordingly can be regulated directly by way of the open cell content. The flow resistance can be determined, for example, in accordance with standard ISO 9053. The flow resistance is determined as the ratio of the pressure difference on either side of a specimen to atmospheric pressure and the volume flow passing through the specimen.

The air permeability is also associated with the flow resistance. Low flow resistance means high air permeability. According to standard EN ISO 7231, the air permeability is defined as the volume flow rate required to maintain a constant pressure gradient over a specimen of flexible foamed material.

The fineness of the cells of the PUR foam is determined by means of the process described in DE-A 102 56 797, from an image of the cut edge of the foam. The cut edge of the foam is understood as being that part of the surface that is obtained after cutting of the foam from a region in the middle of the foamed specimen.

The starting point for the process is the recording of an image (scanner image, light microscope image, electron microscope image or the like) of part of the surface or cut edge, which may also contain faults, with the image then being digitised and evaluated. For evaluation, the digitised image is represented in steps of grey in a matrix, and then several arbitrary rows and/or columns and/or diagonals of grey-step values are selected from the matrix, with the rows or columns or diagonals preferably being chosen to be equidistant from one another, to form several sets of grey-step values of rows or columns or diagonals. The autocorrelation function for each set of grey-step values is then calculated and a mean autocorrelation function is determined from all the autocorrelation functions. From this autocorrelation function, in the region of the maximum close to x=0, a measured value which characterises the size of the cell structure is determined. A particularly suitable measured value has been found to be the direct width of the autocorrelation function at ½ to ¾ of the height of the autocorrelation function over the base of the uncorrelated signals (=value of the autocorrelation function at very large distances). Large numbers here mean a coarse cell structure, and small numbers mean a fine cell structure.

By using the particles of the invention in a process for the production of polyurethane foams, the present invention allows the open cell content of the resultant foams to be reduced and the size of the foam cells to be reduced, and accordingly, permits the production of fine-celled PUR foams.

It can be advantageous to reduce the open cell content of a polyurethane foam for various reasons. These include, for example, the improvement in the acoustic properties (sound insulation) and the improvement in the heat insulation.

Also, it can be advantageous to reduce the cell size of a polyurethane foam for various reasons. Reasons include, for example, to improve acoustic properties, to improve evacuatability in sandwich elements, to avoid subsequent mechanical treatment (pressing open), etc.

The prior art discloses little information concerning reducing the open cell content of a polyurethane foam.

However, various possibilities are known and described in the prior art for increasing the open cell content of a polyurethane foam, that is to say for opening closed cells in polyurethane foamed materials.

It is, for example, possible to open the cells in flexible polyurethane foams mechanically by flexing the corresponding moldings after they have been removed from the mold. This process is widely used but is both time-consuming and expensive in terms of energy and can be used only when producing moldings.

Cell opening is more frequently carried out by chemical means. For example, U.S. Pat. No. 3,405,216 and U.S. Pat. No. 3,495,217 disclose treating flexible polyurethane foamed materials with 15 solutions of inorganic salts. This process is time-consuming owing to the additional working step.

The addition of additives for cell opening is very important. For example, FR-A 1 461 357 discloses the use of hydrocarbons as cell-opening agents. In U.S. Pat. No. 4,826,883 and U.S. Pat. No. 4,863,975, oxynitrate salts are used as cell-opening agents, and in EP-A 0 068 281, hydroxyalkylamines of organic polyacids are employed as cell-opening agents. The use of siloxanes and polysiloxane-polyoxyalkylene block polymers as cell-opening agents is also known and is described, for example, in DE-A 39 28 867. Another possible method of influencing the open cell content of flexible polyurethane foamed materials is the chemical structure of the polyetherols used as the polyol component. For example, by the addition of specially constructed polyetherols to the polyol component, it is also possible to produce open-cell flexible polyurethane foamed materials. As described in DE-A 12 48 286, open-cell flexible polyurethane foams can be produced by, for example, using low molecular weight polyglycols. In U.S. Pat. No. 4,596,665, polyoxyalkylene oxide based on higher alkylene oxides, e.g. 1,2-butylene oxide, is described as a suitable polyether polyol to produce open-cell polyurethane foams.

In EP-A 0 339 369, a polyetherol having a functionality of at least 4 and a molecular weight of at least 5000 is disclosed as a cell-opening agent. However, the use of such polyetherols in flexible polyurethane foam systems leads to relatively rigid foams, which is not desirable for all applications.

In EP-A 0 380 993, polyetherols having a total ethylene oxide content of from 25 to 80 wt. %, in combination with carbonic acid diamide, tricarbonic acid diamide or derivatives thereof, are described for cell opening. In this case, however, the cell-opening polyetherol must be used in a large amount, i.e. at least 50 wt. % of the total amount of polyol. The resultant flexible polyurethane foam systems exhibit the known disadvantages of foams containing polyether alcohols having a high ethylene oxide content. These highly polar polyetherols which have a high ethylene oxide content are poorly miscible with the non-polar polyetherols and isocyanates conventionally employed in polyurethane production. In order to avoid separation of the polyetherol component, constant efficient homogenisation of the finished polyol component is necessary. This is often not carried out, and results in defects in the foam. The use of aqueous salt solutions is also known.

DE-A 40 21 327 describes the use of alkali silicate solutions for cell opening. In this case too, the cell-opening action is achieved at the expense of the mechanical properties, i.e. the foam generally becomes more flexible.

GB-1 533 989 describes the use of silica dispersions (silica gels) as cell-opening reagent. These dispersions of unknown surface functionalisation in the micrometer range are introduced into the formulation with the polyol and have only a cell-opening action. Subsequent mechanical opening is superfluous as a result. However, some of the silica systems that are used tend to shrink the foam. Furthermore, it is only possible to open cells, but not to regulate the open cell content. Regulation of the open cell content is absolutely necessary, however, for the targeted adjustment of, for example, acoustic properties (sound insulation).

The prior art discloses little to no information about increasing the fineness of the cells of a polyurethane foam.

According to the conventional foaming theory, so-called nucleation seeds form during mixing of the starting components, and the blowing agent diffuses into these nucleation seeds. The amount of seeds determines the size of the cell diameters at a given foam density. In conventional water-blown, rigid foams having a density of from 30 to 40 g/l, the concentration of nucleation seeds is from 10⁶ to 10⁷ seeds/g of foam, which results in cell diameters of approximately from 200 to 300 μm.

EP-A 035 614 describes a process in which perfluoro compounds are introduced by emulsification, with cell diameters of 100 μm being achieved. The precise mechanism of the nucleating action is unknown. It is believed that the low interfacial surface tension is the reason. These foams are, however, rigid foams.

According to DE-A 198 04 918, reduced cell diameters are achieved when both the polyol component and the isocyanate component are freed of air beforehand by evacuation. This is completely unexpected, in so far as the removal of the air, which according to current opinion is very important for the formation of nucleation seeds, would have been expected to result in the absence of nucleation and accordingly only produce very coarse-celled foams. The evacuation of all the starting components is generally too expensive, however, for this to be commercially useful.

DE-A 199 05 989 discloses that when a polyisocyanate is foamed with a water-containing polyol formulation in emulsion form, fine-celled rigid polyurethane foams are obtained. This process has the disadvantage that only polyols that are immiscible or very sparingly miscible with water can be used, because otherwise an emulsion does not form. In addition, the process is aimed at water as blowing agent and thus, can only be used for rigid foams.

### SUMMARY OF THE INVENTION

The object underlying the present invention is to reduce the open cell content and the cell size of polyurethane foams in a targeted manner.

The present invention comprises a process for the production of a polyurethane foam. This process comprises reacting
a) one or more polyisocyanates, and
b) one or more polyols, in the presence of
c) one or more blowing agents, and
d) particles.

The particles d) comprise the reaction product of (1) carrier particles, with (2) a functionalising reagent G. The functionalising reagent G contains reactive groups G¹ by means of which G can be chemically bonded to the surface of the carrier particles, and the functionalising reagent G also contains reactive groups G² which, under the conditions of the polyurethane foam production, are reactive towards the NCO groups of said polyisocyanate a), or towards the OH groups of the polyol b), or both. In addition, the reactive groups G¹ and the reactive groups G² may be the same or different.

According to a preferred embodiment of the process of the present invention, polyurethane foams (which ar preferably rigid) are produced by reacting a) one or more polyisocyanates (preferably at least difunctional isocyanates) with b) one or more polyols having, on average, preferably at least three hydroxyl groups per molecule, in the presence of c) one or more blowing agents, and optionally catalysts and optionally conventional additives, and d) particles as described hereinabove.

### DETAILED DESCRIPTION OF THE INVENTION

A summary of the prior art, of the raw materials used and of processes which may be employed will be found in “Kunststoffhandbuch”, Volume VII, by G. Oertel, C. Hanser Verlag, Munich, 1983, in “Methoden der organischen Chemie; Houben-Weyl”, 1987, Volume E20, by H. Bartl and J. Falbe, pages 1561 to 1757, and in “Ullmann's Encyclopedia of Industrial Chemistry” 1992, Vol. A21, pages 665 to 715.

In general, the suitable polyols include, for example, those polyether polyols or polyester polyols or mixtures thereof, in which the polyol or mixture of polyols preferably contains on average at least three hydroxyl groups per molecule, and the hydroxyl number of the polyol or mixture of polyols ranges preferably from 100 to 900.

In addition, the blowing agents preferably include, for example, volatile organic compounds having boiling points below 60° C., or alternatively water, as well as combinations of the two. The water reacts with the isocyanate component to form carbon dioxide and amine, which in turn reacts further with the isocyanate component to form polyurea.

The resulting rigid polyurethane foamed materials have, for example, a weight per unit volume of from about 5 to about 950 kg/m³.

It is particularly preferred that polyol formulations used in the process of the present invention contain at least one compound having at least two isocyanate-reactive hydrogen atoms, which preferably has a (number average) molecular weight of from 150 to 12,500 g/mol (more preferably from 200 to 1500 g/mol), and which has at least one tertiary nitrogen atom in the molecule. Such compounds can be obtained, for example, by polyaddition of alkylene oxides, such as, for example, ethylene oxide, propylene oxide, butylene oxide, dodecyl oxide or styrene oxide, preferably propylene oxide or ethylene oxide, to suitable starter compounds.

Examples of compounds which are suitable for use as starter compounds include, for example, ammonia, as well as compounds that contain at least one primary or secondary or tertiary amino group, such as, for example, aliphatic amines, such as ethylenediamine, oligomers of ethylenediamine (for example diethylenetriamine, triethyleneteramine or pentaethylenehexamine), ethanolamine, diethanolamine, triethanolamine, N-methyl-diethanolamine, N-ethyl-diethanolamine, 1,3-propylenediamine, 1,3-butylenediamine, 1,4-butylenediamine, 1,2-hexamethylenediamine, 1,3-hexamethylenediamine, 1,4-hexamethylenediamine, 1,5-hexamethylenediamine, 1,6-hexamethylenediamine, aromatic amines, such as phenylenediamines, toluylenediamines (2,3-toluylenediamine, 3,4-toluylenediamine, 2,4-toluylenediamine, 2,5-toluylenediamine, 2,6-toluylenediamine or mixtures of the mentioned isomers), 2,2′-diaminodiphenylmethane, 2,4′-diaminodiphenylmethane, 4,4′-diaminodiphenylmethane or mixtures of these isomers, etc.

In addition, it is also possible to use at least one polyester polyol having a (number average) molecular weight of from about 100 to about 30,000 g/mol, preferably from about 150 to about 10,000 g/mol, and more preferably from about 200 to about 600 g/mol, comprising the reaction product of aromatic and/or aliphatic dicarboxylic acids, and polyols containing at least 2 hydroxyl groups. Examples of suitable dicarboxylic acids are phthalic acid, fumaric acid, maleic acid, azelaic acid, glutaric acid, adipic acid, suberic acid, terephthalic acid, isophthalic acid, decanedicarboxylic acid, malonic acid, glutaric acid and succinic acid. It is possible to use the pure dicarboxylic acids as well as any desired mixtures thereof. Instead of the free dicarboxylic acids, it is also possible to use the corresponding dicarboxylic acid derivatives, such as, for example, dicarboxylic acid mono-esters or di-esters of alcohols having from 1 to 4 carbon atoms or dicarboxylic anhydrides. The following compounds are preferably used as the alcohol component for the esterification: ethylene glycol, diethylene glycol, triethylene glycol, tetraethylene glycol, 1,2- or 1,4-propanediol, 1,4-butanediol, 1,5-pentanediol, 1,6-hexanediol, 1,10-decanediol, glycerol, trimethylolpropane or mixtures thereof.

The polyol formulations may also contain polyether esters, as may be obtained, for example, by the reaction of phthalic anhydride with diethylene glycol, and subsequently with ethylene oxide.

The catalysts which are known and are conventional in polyurethane chemistry can be used in accordance with the present invention. Some examples of such catalysts are: triethylenediamine, N,N-dimethylcyclohexylamine, tetramethylenediamine, 1-methyl-4-dimethylaminoethylpiperazine, triethylamine, tributylamine, dimethylbenzylamine, N,N′,N″-tris-(dimethylaminopropyl)-hexahydrotriazine, dimethylaminopropylformamide, N,N,N′,N′-tetramethy-lenediamine, N,N,N′,N′-tetramethylbutanediamine, tetramethylhexanediamine, pentamethyldiethylenetriamine, tetramethyldiaminoethyl ether, dimethyl-piperazine, 1,2-dimethylimidazole, 1-aza-bicyclo-(3,3,0)-octane, bis-(dimethylaminopropyl)-urea, N-methylmorpholine, N-ethylmorpholine, N-cyclohexylmorpholine, 2,3-dimethyl-3,4,5,6-tetrahydropyrimidine, triethanol amine, diethanolamine, triisopropanolamine, N-methyldiethanolamine, N-ethyldiethanolamine, dimethylethanolamine, tin(II) acetate, tin(II) octoate, tin(II) ethylhexoate, tin(II) laurate, dibutyltin diacetate, dibutyltin dilaurate, dibutyltin maleate, dioctyltin diacetate, tris-(N,N-dimethyl-aminopropyl)-s-hexahydrotriazine, tetramethylammonium hydroxide, sodium acetate, potassium acetate, sodium hydroxide or mixtures of these or similar catalysts.

Suitable polyisocyanates to be used herein as the isocyanate component include, for example, aromatic polyisocyanates, as are described, for example, by W. Siefken in Justus Liebigs Annalen der Chemie, 562, pages 75 to 136. These include, for example, those polyisocyanates which correspond to the formula:
Q(NCO)ₙ
in which
n represents from 2 to 4, preferably 2, and
Q represents an aliphatic hydrocarbon radical having from 2 to 18 carbon/ atoms, preferably from 6 to 10 carbon atoms, a cycloaliphatic hydrocarbon radical having from 4 to 15 carbon atoms, preferably from 5 to 10 carbon atoms, an aromatic hydrocarbon radical having from 8 to 15 carbon atoms, preferably from 8 to 13 carbon atoms, e.g. polyisocyanates such as those described in DE-OS 28 32 253, pages 10 to 11. DE-OS 28 32 253 is believed to correspond to U.S. Pat. No. 4,263,408, the disclosure of which is hereby incorporated by reference.

In general, it is particularly preferred to use the polyisocyanates which are readily available industrially. These include, for example, 2,4- and 2,6-toluylene diisocyanate and any desired mixtures of these isomers (“TDI”), polyphenylpolymethylene polyisocyanates, as are prepared by aniline-formaldehyde condensation and subsequent phosgenation (“crude MDI”), and polyisocyanates containing carbodiimide groups, urethane groups, allophanate groups, isocyanurate groups, urea groups or biuret groups, “modified polyisocyanates”, especially modified polyisocyanates derived from 2,4- and 2,6-toluylene diisocyanate or from 4,4′- and/or 2,4′-diphenylmethane diisocyanate.

It is also possible to use prepolymers of the above mentioned isocyanates. Prepolymers are prepared by reacting an isocyanate with one or more organic compounds having at least one hydroxyl group. Suitable organic compounds include compounds such as, for example, polyols or polyester components containing from 1 to 4 hydroxyl groups and having a molecular weight of from 60 to 1400.

Auxiliary substances such as paraffins, fatty alcohols or dimethylpolysiloxanes as well as pigments or colorings, also stabilizers against the effects of ageing and weathering, plasticizers and substances having a fungistatic and bacteriostatic action, as well as fillers such as barium sulfate, kieselguhr, carbon black or prepared chalk, can optionally also be used in the polyurethane foams of the invention.

Further examples of surface-active additives and foam stabilizers which can optionally be used, as well as cell regulators, reaction retardants, stabilizers, flame-inhibiting substances, colorings and fillers, as well as substances having fungistatic and bacteriostatic action, and details of the use and mode of action of these additives are described in Kunststoff-Handbuch, Volume VII, published by Vieweg and Höchtlen, Carl Hanser Verlag, Munich 1966, e.g. on pages 121 to 205, and 2nd Edition 1983, published by G. Oertel (Carl-Hanser-Verlag, Munich).

The process according to the invention for the production of foamed materials can be carried out as a block foaming operation or in the manner of the double transport process known per se or alternatively as a high-pressure process (RIM), for example for molded foams (seats, etc.). The Isocyanate Index for the process and products of the invention is preferably in the range of from about 50 to about 150.

The particles d) of the present invention are obtained by reacting (1) carrier particles with (2) a functionalising reagent G.

Suitable materials to be used as (1) the carrier particles in the preparation of the particles d) include, for example, organic particles, inorganic particles and inorganic-organic particles. Inorganic particles are preferred. Some examples of suitable organic particles include, but are not limited to, polymethyl methacrylate (PMMA) particles, ABS (acrylonitrile-butadiene-styrene) particles, and SAN (styrene-acrylonitrile) particles. The inorganic particles may be, for example, silica gel particles, SiO₂ particles, TiO₂ particles, ZrO₂ particles, etc. Silica gel particles and SiO₂ particles are particularly preferred.

Functionalising reagents G (2) which are used to prepared the particles d) for the present invention contain reactive groups G¹ which enable the functionalising reagent G to be chemically bonded to the surface of the carrier particles (1). The functionalising reagent G additionally contains reactive groups G² which, under conditions typically for polyurethane foam production, are reactive towards the NCO groups of the polyisocyanate component, the OH groups of the polyol component, or both. The reactive groups G¹ and G² of the functionalising reagent may be the same or may be different. Aminopropyltriethoxysilane is a preferred functionalising reagent G.

In a particular embodiment of the present invention, the carrier particles (preferably silica gel particles) are reacted with a silanising reagent as the functionalising reagent G. By means of silanisation, it is possible to achieve chemical bonding of organic, inorganic, or inorganic-organic (preferably inorganic) carrier particles with the organic matrix of a polyurethane foam. The silanisation can be carried out by reaction of a silane component which, for example, corresponds to the formula t
(R¹,R²,G²)Si—G¹,
wherein:

G¹: represents a halogen atom or an alcoholate group,
R¹ and R²: may be the same or different and are selected independently from the group consisting of a halogen atom, an alcoholate group, an alkylamine group, an alkanol group, an alkyl group, a methacrylate group and an alkyl isocyanate group,
G²: is selected from the group consisting of an alkylamine group, an alkanol group, an alkyl group, a methacrylate group, an alkyl isocyanate group.

A particular embodiment of the present invention is as follows. Particles which are reactive towards NCO groups of the polyisocyanate component and/or OH groups of the polyol component can be prepared by means of silanising compounds which correspond to the above formula wherein: R¹ and R² may be the same or different and are independently selected from the group consisting of the halogens (especially chlorine), alcoholates (especially methanolate group, ethanolate group), isocyanate groups (for example (EthO)₃—Si—NCO), alkylamines and arylamines (frequently propylamine, but anilines are also suitable) as well as alkyl alcohols and aryl alcohols. This means that suitable functionalising reagents G include, for example, trialkoxy-alkylamine-silanes, dialkoxy-dialkylamine-silanes, alkoxy-trialkylamine-silanes, trichloro-alkyl-aminesilanes, dichloro-dialkylamine-silanes, chloro-trialkylamine-silanes, as well as chloro-, alkoxy, alkylamines, and arylamine permutations of the above. Instead of arylamines and alkylamines, the corresponding alcohols are suitable. The amine or alcohol groups react with the isocyanate and are incorporated covalently, or the Si—NCO particles react with the polyol and are likewise incorporated covalently.

The mean particle diameter of the particles d) of the invention is preferably from about 1 nm (more particularly preferably from about 10 nm, and most preferably from about 50 nm) to about 500 micromeetes( preferably to about 100 micrometers, more preferably to about 10 micrometers, and most preferably to about 1000 nanometers). A suitable method for determining the mean particle diameter is standard DIN 4022 and other DIN standards, as described, for example, in “DIN-Taschenbuch Partikelmesstechnik, Normen, Beuth-Verlag, Berlin, Cologne, 1990”.

In the scope of the work that led to the present invention, it has been found that there is a pronounced and non-linear correlation between the flow resistance and the acoustic absorption of polyurethane foamed materials. The acoustic absorption coefficient initially increases with the air flow resistance to a maximum, and then falls again as the air flow resistance increases. It is advantageous to adjust the flow resistances in the range of the maximum absorption coefficient, in order to provide sound-absorbing polyurethane foamed materials. This is possible by means of the process according to the invention.

Another advantage of the present invention is that the mechanical properties (e.g. compression hardness, density, etc.) and the kinetic properties (e.g. start time, gelling time, etc.) of the polyurethane foams according to the invention are not too greatly impaired.

A particular embodiment of suitable particles d) for the present invention is described hereinbelow. Using carrier particles which are, for example, silica gel dispersions or SiO₂ dispersions which have a particle size in the nanometer range. (or other suitable types of dispersions ), the particle surface is rendered hydrophilic by means of, for example, silanising reagents or by condensation. A hydrophilic surface having surface groups that are reactive towards isocyanate groups (NCO groups) by means, for example, OH groups, NH2 groups and/or NH groups, is incorporated covalently into the polymer matrix of the foam during the polymerization reaction to form the polyurethane foam and acts as a strengthening element. This results in the foam being more closed (i.e. closed-cell) than without the particles d) of the present invention as previously described.

The mechanical properties of the produced polyurethane foams are affected to only a small extent by the physico-chemical action of the particles d).

The particles d) may be incorporated into the polyol of the polyurethane formulation (PUR formulation). These particles are preferably incorporated into the polyol component such that the concentration is from about 0.1 (preferably about 0.5, and more preferably about 1) wt. % to about 10 (preferably about 3.5, and more preferably about 2.5) wt. % .

The silicon dioxide particles which are particularly suitable for use as the carrier particles (1) are prepared by known processes and preferably include those which are available commercially. Some examples include, but are not limited to, silica particles from Wacker (commercially available under the name HDK) and Degussa (commercially available under the names Sipernat, Ultrasil, and Aerosil).

For acoustic applications (e.g. sound insulation) of foams, the acoustic absorption coefficient is of critical importance and is required as a quality parameter by the, automotive industry. As already mentioned, the absorption coefficient correlates in a non-linear manner with the flow resistance of foamed materials. In any frequency range, there is a flow resistance interval within which a maximum acoustic absorption coefficient is reached. In order to achieve this maximum absorption coefficient, the targeted adjustment of the flow resistance is necessary. This is possible by producing polyurethane foams with the particles of the present invention. The mechanical parameters of the foam which are likewise required are either unimpaired or only negligibly impaired.

Another advantage of the present invention is that the method of the invention for producing fine-celled polyurethane foams using these particles as an additive (i.e. a cell regulator) whose cell-closing action extends over a wide range of concentrations.

A particular embodiment of the present invention relates to the addition, to the polyol component, of at least one dispersed component in the nanometer range that has been specially functionalised at the surface. These particles can be prepared in accordance with the literature (W. Stöber, A. Fink, E. Bohn, E., J. Colloid Interface Sci. 26, 62 (1968) and Dissertation Ch. Beck, “Licht- und Röntgenstreuung an oberflächenfunktionalisierten Nanopartikeln”, University of the Saarland, 1999), and in some cases are also available commercially (from e.g. Degussa and Wacker), by inorganic condensation polymerization of tetraethoxysilane (TEOS) in an ammonium-alcoholic medium. The special functionalisation at the surface is carried out by silanisation of the SiO₂ surface, or by condensation of a polyol onto that surface. In this particular embodiment, SiO₂ acts solely as carrier material for the surface functionalisation. Other dispersions which include, on an organic basis (polyurea, PMMA, styrene, etc.), or on an inorganic basis (TiO₂, etc.), are also possible. A hydrophilic surface having alkyl-OH groups or alkyl-NH₂ groups, i.e. groups having at least one compound that is reactive towards the isocyanate component, act as a crosslinking node and accordingly have a cell-closing action. A lipophilic surface, which contains groups that are chemically inert towards the isocyanate component, accordingly acts as a predetermined breaking point, and hence has a cell-opening action during the foam formation.

The following hypothetical mechanism of action may underlie the present invention. Applicants and their invention as claimed are not bound by this theory. Before the start of the foaming reaction, the particles d) are dispersed in the liquid phase consisting of a) polyisocyanate and b) polyol, homogeneously and largely without agglomerates, owing to the surface functionalisation. During the foaming reaction, the foam film becomes ever thinner due to the blowing process. At a point in time at which the thickness of the foam film is able to interact with the surface functionalisation of the particles, the following effect is believed to occur: If the particle surface is reactive towards NCO groups, then the particles are incorporated covalently into the matrix, and accordingly effect an additional mechanical stabilisation, so that the foam film is able to withstand the foaming pressure; with the particle acting as a crosslinking node.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all parts and percentages are parts by weight and percentages by weight, respectively.

### EXAMPLES

Various SiO₂-based organic colloid systems (silica sols or silica gels) were prepared and then functionalised at the surface. In addition, various commercial representatives, commercially available from Wacker and Degussa, were tested.

Typical formulations for the production of the crude silica additives in a one-pot reaction (stirring time at 20° C. was from 2 to 4 hours) are shown in the following table.

| | Methanol, | | Ethanol, | | Isopropanol, | |
|---|---|---|---|---|---|---|
| Solvent | 1200 ml | | 1200 ml | | 1200 ml | |
| Tetraethoxysilane | 42 | ml | 42 | ml | 42 | ml |
| 25% aqueous | 60 | ml | 60 | ml | 60 | ml |
| ammonia solution | | | | | | |
| Surface silane as | 9 | ml | 6 | ml | 3 | ml |
| described in the | | | | | | |
| following sections | | | | | | |
| Particle size D | 100 | nm | 150 | nm | 250 | nm |

In order to render the particle surface hydrophilic, each of the crude systems prepared as specified above were (individually) incorporated in a rotary evaporator into the a polyol (specifically a polyethylene oxide-polypropylene oxide polyether based on glycerol having a number-average molar mass of 4500 g/mol). At a bath temperature of 50° C. and with an optimum low pressure, excess solvent (which changes the OH number of the formulation) was drawn off on the one hand, and the condensation of an OH group of a polyol molecule onto the surface of the particle was effected on the other hand. A similar procedure for low molecular weight alcohols is described by, for example, A. K. van Helden, J. W. Jansen, A. Vrij, in the J. Colloid Interface Sci. 81, 354 (1981). As a result, a 1 to 10 wt. % SiO₂ dispersion was obtained, based on the weighed amount of polyol.

Another variation of the above includes the use of aminopropyl-triethoxy-silane. In this embodiment, aminopropyl-triethoxy-silane was applied to the reactive SiO₂ surface in a condensation reaction. In this case, the protons of the amino group acted as the isocyanate-reactive component. In order to render the particle surface lipophilic, the crude systems prepared as specified above were functionalised by means of triethoxysilylpropyl methacrylate (TPM) and triethoxy-ethyl-silane. In the one-pot reaction, the reagent (6 ml) was present and stirring was carried out for a further 12 hours at RT. In order to incorporate the resulting system into a polyol, the excess alcohol and the excess ammonia were drawn off, as in the preparation of the hydrophilic particles in a rotary evaporator in a polyol (specifically a polyethylene oxide-polypropylene oxide polyether based on glycerol having a number-average molar mass of 4500 g/mol).

By way of example, the additive system was tested in the following formulations in the range from 0 to 4 wt. % , based on the polyol. Aminopropyltriethoxysilane was used in the formulations, and SiO₂ carrier particles having a size of 150 nm.

Flexible Foam Formulation:

| Starting material | Parts by weight |
|---|---|
| Polyethylene oxide-polypropylene oxide polyether based | 100.00 |
| on glycerol, molar mass 4500 g/mol | |
| H₂O | 3.38 |
| Crosslinking catalyst DABCO 33 LV, Air Products | 0.34 |
| Blowing catalyst Niax A1, Air Products | 0.20 |
| Crosslinker diethanolamine | 0.52 |
| Silicone stabilizer Tegostab, Degussa | 0.29 |
| an MDI isomeric mixture having polymeric constituents; | 57.75 |
| commercially available from Bayer AG | |

The abbreviations and commercial names used in the table have the following meanings:
MDI: methylene-diphenyl diisocyanate
NIAX A1: 70 wt. % bis-(2-dimethylamino-ethyl) ether, 30 wt. % dipropylene glycol
DABCO 33 LV: 33 wt. % triethylenediamine, 66 wt. % dipropylene glycol
Tegostab: a polyether-polysiloxane copolymerization product

Rigid Foam Formulation:

| Starting material | Parts by weight |
|---|---|
| Polypropylene oxide polyether based on sorbitol/glycerol, | 94.7 |
| molar mass 500 g/mol. | |
| H₂O | 2.1 |
| Silicone stabilizer Tegostab, Degussa | 1.4 |
| Blowing catalyst Desmorapid PV, Bayer | 0.5 |
| Crosslinking catalyst Desmorapid 726 B, Bayer | 1.3 |
| c-Pentane | 14 |
| an MDI isomer mixture, commercially available from | 142 |
| Bayer | |

The abbreviations and commercial names used in the table have the following meanings:
Desmorapid 726 B: cyclohexyldimethylamine
Desmorapid PV: pentamethyldiethylenetriamine
Tegostab: a polyether-polysiloxane copolymerization product

The cell-regulating action of the particles was tested in both flexible and rigid foams.

The properties open cell content and flow resistance or air permeability were determined for the flexible foam examples. The cell-regulating action of the particles is shown in the following table.

| | |
|---|---|
| Wt. % | Flexible foam |

| particles | Cell size | Flow resistance |
|---|---|---|
| in the polyol | [μm] | [Pas/m²] |
| 0 | 800 | 30,000 |
| 1 | 500 | 36,700 |
| 2 | 325 | 39,100 |
| 3 | 220 | 35,400 |
| 4 | 150 | 50,900 |

The regulating action in rigid foams is shown in the following table.

| Wt. % particles in | Mean cell size |
|---|---|
| the polyol | [μm] |
| 0% | 350 |
| 2% | 250 |
| 4% | 150 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for the production of a polyurethane foam, comprising reacting
a) a polyisocyanate, and
b) a polyol, in the presence of
c) a blowing agent and
d) particles which are obtained by reacting (1) carrier particles with (2) a functionalising reagent G,
wherein said functionalising reagent G contains reactive groups G¹ by means of which G can be chemically bonded to the surface of the carrier particles,
and wherein said functionalising reagent G additionally contains reactive groups G² which, under the conditions of the polyurethane foam production, are reactive towards the NCO groups of said polyisocyanate a), or towards the OH groups of the polyol b), or both,
and wherein reactive groups G¹ and reactive groups G² may be the same or different.

2. The process of claim 1, wherein (1) said carrier particles are selected from the group consisting of organic carrier particles, inorganic carrier particles, inorganic-organic carrier particles and mixtures thereof.

3. The process of claim 2, wherein (1) said carrier particles comprise organic carrier particles selected from the group consisting of polymethyl methacrylate particles, ABS particles, SAN particles and mixtures thereof.

4. The process of claim 2, wherein (1) said carrier particles comprise inorganic carrier particles are selected from the group consisting of silica gel particles, SiO₂ particles, TiO₂ particles, ZrO₂ particles and mixtures thereof.

5. The process of claim 2, wherein the carrier particles are selected from the group consisting of silica gel particles and SiO₂ particles.

6. The process of claim 1, wherein the reactive groups G¹ are selected from the group consisting of an alkoxy group and a halogen atom.

7. The process of claim 6, wherein the alkoxy group comprises a methoxy group or an ethoxy group.

8. The process of claim 6, wherein said halogen comprises a chlorine atom.

9. The process of claim 1, wherein the reactive groups G² are selected from the group consisting of amino groups, OH groups, aminoalkyl groups, OH-alkyl groups, aminoaryl groups, OH-aryl groups, isocyanate groups, alkyl-NCO groups, aryl-NCO groups and silazane groups.

10. The process of claim 1, wherein the carrier particles comprise silica gel particles and wherein the functionalising reagent G comprises aminopropyltriethoxysilane.

11. The process of claim 1, in which the open cell content and/or the fineness of the cells of the polyurethane foams is regulated by d) said particles.

12. The polyurethane foam produced by the process of claim 1.

13. A composition comprising (I) a polyol, and (II) particles which comprise the reaction product of (1) carrier particles and (2) a functionalising reagent G, which contains reactive groups G¹ by means of which G can be chemically bonded to the surface of the carrier particles, and which additionally contains reactive groups G² which are reactive towards the NCO groups of a polyisocyanate, or towards the OH groups of a polyol, or both, and wherein reactive groups G¹ and G² may be the same or different.

14. A composition comprising (I) a polyisocyanate and (II) particles which comprise the reaction product of (1) carrier particles and (2) a functionalising reagent G, which contains reactive groups G¹ by means of which G can be chemically bonded to the surface of the carrier particles, and which additionally contains reactive groups G² which are reactive towards the NCO groups of a polyisocyanate, or towards the OH groups of a polyol, or both, and wherein reactive groups G¹ and G may be the same or different.

15. In a process for the production of polyurethane foams, comprising reacting a polyisocyanate component with a polyol component, the improvement wherein said polyisocyanate component comprises the composition of claim 14.

16. In a process for the production of polyurethane foams, comprising reacting a polyisocyanate component with a polyol component, the improvement wherein said polyol component comprises the composition of claim 13.
